(19) United States
(12) Patent Application Publication
(10) Pub. No.: US 2003/0132956 A1
(43) Pub. Date: Jul. 17, 2003

(54) Method, system, and program for managing a configuration file including device driver parameters

(75) Inventors: William L. Duncan, Berthoud, CO (US); Ian F. Reeve, Thornton, CO (US)

Correspondence Address: David W. Victor, KONRAD RAYNES VICTOR & MANN LLP, Suite 210, 315 S. Beverly Drive, Beverly Hills, CA, 90212, US

(73) Assignee: Sun Microsystems, Inc.

(21) Appl. No.: 10/051,509

(22) Filed: Jan. 16, 2002

(51) Int. Cl. G09G 5/00

(52) U.S. Cl. 345/735

(57) ABSTRACT

Provided are a method, system, and program for managing a configuration file including device parameters defining attributes of at least one device. A device driver uses the device parameters to control the at least one device. An association is provided of device parameters and parameter codes for devices accessible through the device driver, wherein the device parameters define attributes of the devices. Information is presented on the device parameters through a user interface. User selection is received of at least one of the device parameters. A determination is made from the association of the parameter code corresponding to the user selected device parameter for each user selected device parameter. The configuration file is then modified to include each determined parameter code.

### BACKGROUND OF THE INVENTION

1. Field of the Invention

The present invention relates to a method, system, and program for managing a configuration file including device driver parameters.

2. Description of the Related Art

A tape drive or other device attached to a computer system requires the support of a device driver installed on the computer system. A device driver program functions as an interface between the computer operating system and application programs executing thereon and the device. The computer programs and operating system access the device through the device driver by communicating generic device commands that the device driver translates to device-type specific commands to control device operations.

A device driver program includes a built-in configuration table having device parameters that are used when configuring and communicating with the device. Unix** systems further provide a configuration file, known as the “.conf” file, in which the user may set certain device parameters that are then used by the device driver in place of any parameters included in the configuration table compiled or provided with the device driver. During operations, the device driver will first check the configuration file (.conf), and if there are active user set parameters, then the device driver will use those active parameters included in the configuration file. Otherwise, the device driver will use the parameters in the configuration table provided (compiled) with the device driver program. For instance, a device driver is provided for tape drives. Although the device driver program can utilize the standard tape driver settings, performance is optimized by modifying the tape configuration file, known as “st.conf”, with the geometry parameters the vendor recommends for the installed tape drive. For instance, the user may define in the tape configuration file (st.conf) a maximum of four densities for a particular drive designation, e.g., Digital Linear Tape (DLT) 8000 compliant devices support a density of 0x88 for the 40 gigabyte (GB) uncompressed mode and 0x89 for 80 GB compressed mode. Additional values can be selected based on the types of cartridges and densities available for the DLT capabilities of the tape drive. Thus, users can optimize performance by properly adding settings to the configuration file to support the specific capabilities of the attached device.

The settings in the configuration file comprise hexadecimal codes that have specific syntax requirements. The configuration file (.conf) file syntax is highly sensitive to typographical errors. If the user manually enters parameter settings into the configuration file that include a syntax error, then the system will display a series of error messages during the subsequent reboot. Customer support for system vendors often receive numerous calls from customers reporting system errors resulting from typographical errors in their entries in the configuration file. The customers reporting such problems are often unaware that inappropriate syntax in the codes they added to the configuration file is the source of the problem.

For these reasons, there is a need in the art to provide improved techniques to allow a user to manage and modify the device configuration files.

### SUMMARY OF THE PREFERRED EMBODIMENTS

Provided are a method, system, and program for managing a configuration file including device parameters defining attributes of at least one device. A device driver uses the device parameters to control the at least one device. An association is provided of device parameters and parameter codes for devices accessible through the device driver, wherein the device parameters define attributes of the devices. Information is presented on the device parameters through a user interface. User selection is received of at least one of the device parameters. A determination is made from the association of the parameter code corresponding to the user selected device parameter for each user selected device parameter. The configuration file is then modified to include each determined parameter code.

In further implementations, user input is received requesting accessible devices. Ports are queried to determine accessible devices and information is presented on the determined devices through the user interface.

Yet further, user input is received selecting one of the determined devices presented through the user interface. The user interface presents the information on the selectable device parameters in response to receiving selection of one of the determined devices. The configuration file is then modified to include the determined parameter code for the selected device.

In certain implementations, the user interface comprises at least one Graphical User Interface (GUI) panel. One panel displays information on each of the selectable device parameters and an input mechanism to enable the user to enter user input selecting at least one of the device parameters.

Further provided is a method, system, and program for managing a configuration file including device parameters defining attributes of at least one device. A device driver uses the device parameters to control the at least one device. A user interface is presented through which the user enters information on a name of a device driver and an identifier of a device. User input is received for at least one device indicating the identifier of the device and the name of the device driver that is used to communicate with the device. The received user input for the at least one device is stored in the configuration file. The named device driver uses the stored input information during initialization to establish communication with the devices for which user input is received.

In further implementations, user input is received for a plurality of devices linked together and the received identifier of each device comprises a number of the device relative to the other devices linked together.

### BRIEF DESCRIPTION OF THE DRAWINGS

Referring now to the drawings in which like reference numbers represent corresponding parts throughout:

FIG. 1 illustrates a computing environment in which aspects of the invention are implemented;

FIGS. 2, 3, and 4 illustrate Graphical User Interface (GUI) panels to enable the user to manage and modify a configuration file used by a device driver in accordance with certain implementations of the invention;

FIGS. 5a, 5b, 5c and 6 illustrate logic to manage and modify the configuration file in accordance with implementations of the invention;

FIGS. 7 and 8 illustrate GUI panels to enter information on attached devices in accordance with certain implementations of the invention; and

FIG. 9 illustrates additional implementation details of the computing environment of FIG. 1 in accordance with implementations of the invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

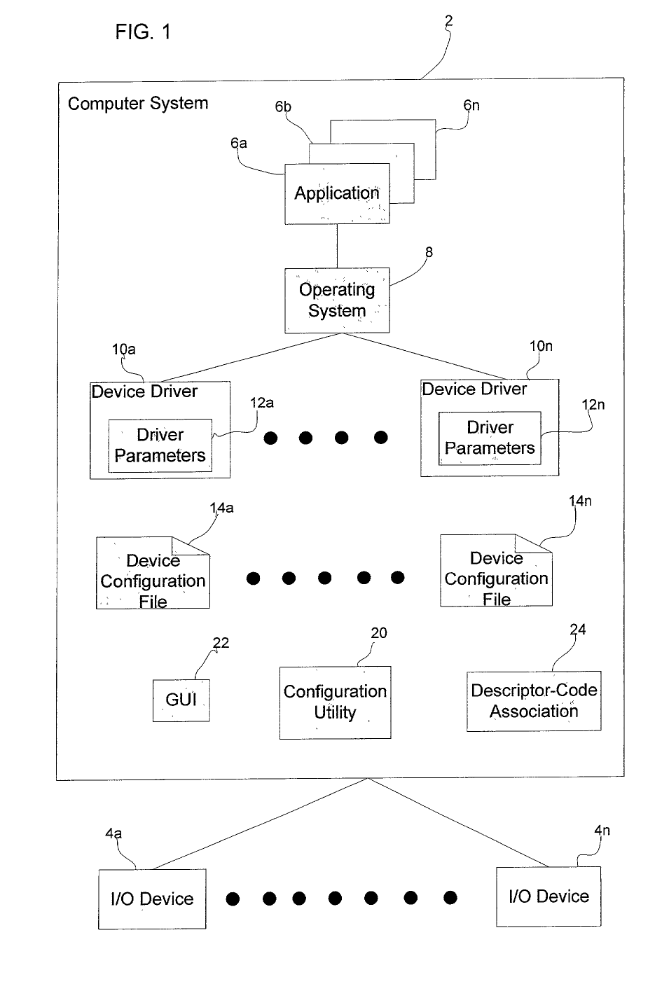

FIG. 1 illustrates a computing environment in which aspects of the invention are implemented. A computer system 2 is capable of communication with one or more Input/Output (I/O) devices 4a . . . 4n, such as storage devices (e.g., disk drives, tape drives, optical disk drives, etc.), printers, display devices, or any other I/O device known in the art. The computer system 2 may communicate with the I/O devices 4a . . . 4n over a network (not shown), a direct connection (serial, cable, Universal Serial Bus (USB), Fire Wire, fiber optical wire, wireless, etc.), or the I/O devices 4a . . . 4n may be located in an Input/Output bay of the computer system 2 housing. The computer system 2 includes one or more application programs 6a . . . 6n, which may comprise any application program known in the art (e.g., a database program, backup program, file management system program, etc.) and an operating system 8. The computer system 2 may comprise any type of computing device known in the art, such as a workstation, desktop computer, server, mainframe, laptop, hand held computer, telephony device, etc.

A plurality of device driver programs 10a . . . 10n are installed on the computer system 2. Each device driver 10a . . . 10n includes driver parameters 12a . . . 12n that the device driver 10a . . . 10n uses when configuring and communicating device specific commands to the I/O devices 4a . . . 4n controlled by the device driver. The driver parameters 12a . . . 12n are provided, i.e., compiled, with the driver 10a . . . 10n and may be updated when the device driver 10a . . . 10n is updated. Further, associated with each different device driver 10a . . . 10n is a device configuration file 14a . . . 14n that maintains user entered settings. In implementations where the operating system 8 is the Unix operating system, the configuration files 14a . . . 14n would comprise the “.conf” files maintained to provide user entered parameters for the device drivers, such as the “st.conf” that provides parameters for tape drive drivers. In non-Unix implementations, the configuration file accessed by the device driver to obtain user entered settings may have a different format and naming convention.

The described implementations provide a configuration utility program 20 that generates a graphical user interface (GUI) 22 through which the user may view and modify the parameter settings in the configuration files 14a . . . 14n. The configuration utility program 20 maintains an association of parameter descriptors and parameter codes 24 (referred to herein as a “descriptor-code association 24”) that associates a human readable descriptor of each settable parameter with the parameter code, e.g., hexadecimal code, that is included in the configuration file 14a . . . 14n. The descriptor-code association 24 may be maintained as a separate file or may be embedded in the configuration utility 20 or GUI 22 code.

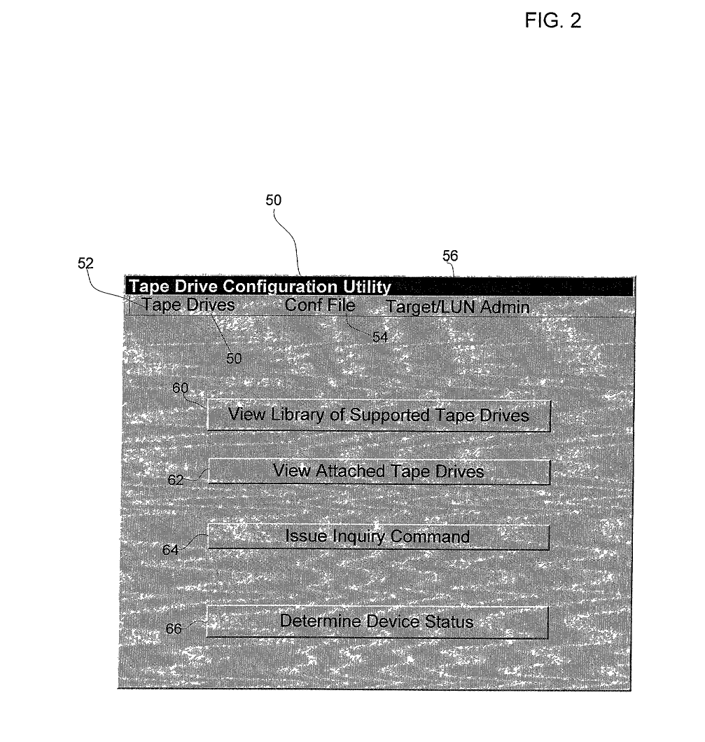

In one implementation, the configuration utility 20 may enable a user to manage and modify the configuration file (e.g., “st.conf”) for attached I/O devices 4a . . . 4ncomprising tape drives. FIG. 2 illustrates an example of a GUI panel 50 generated by the configuration utility 20 to manage information on attached tape drives. The GUI panel 50 includes two selectable menu items labeled “Tape Drives” 52 and “Conf File” 54. The panel in FIG. 2 shows the selectable controls displayed upon selection of the Tape Drives 52 menu item. The controls the user may select include:

View Library of Supported Tape Drives 60: causes the display of all manufacturers and models of tape drives that are supported by the installed tape driver.

View Attached Tape Drives 62: Displays the tape drive devices accessible to the computer system 2. Such tape drive devices would have been determined by a previous issuance of an inquiry command, such as the Small Computer System Interface (SCSI) command in the case of SCSI tape drives.

Issue Inquiry Command 64: causes the issuance of an inquiry command, such as the SCSI inquiry command, to specific tape drives in order to determine if an individual or group of tape drives are accessible and/or attached.

Determine Device Status 66: issues a command, such as the “mt status” command to determine the current status of an individual or group of attached tape drives.

Information on the attached SCSI drives that the configuration utility 20 makes available to the user would be maintained in a file used by the configuraton utility 20. Those skilled in the art will appreciate that alternative GUI mechanisms other than those shown in FIG. 2 may be used to invoke the commands 60, 62, 64, and 66. For instance, the commands 60, 62, 64, 66 may be listed in a drop down list displayed in response to selection of the displayed tape drives 50 menu item.

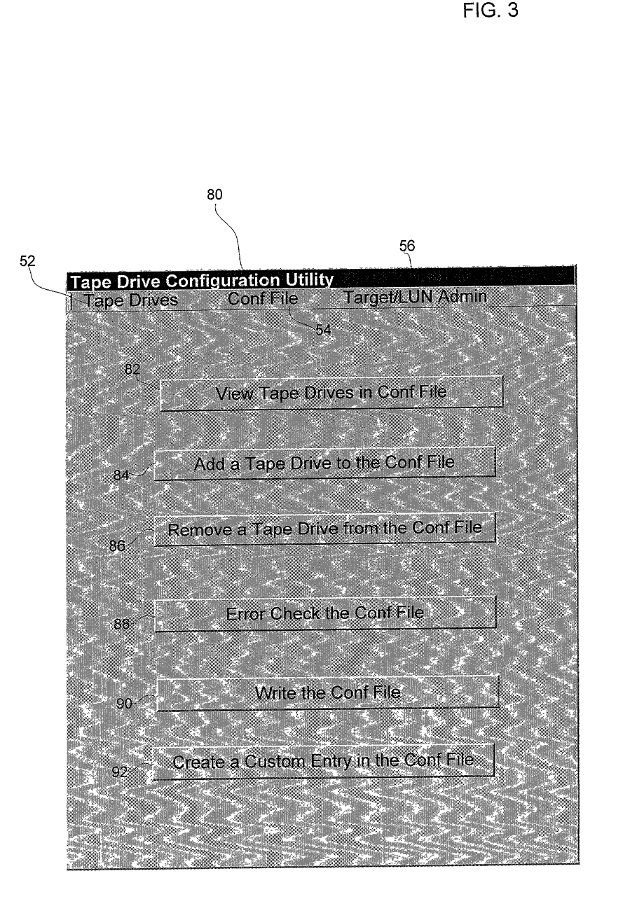

FIG. 3 illustrates an example of a GUI interface 80 displayed in response to selection of the “Conf File” menu item 54 that enables a user to invoke certain configuration file 14a . . . 14n management operations. In GUI interface 80, the operations the user may invoke to manage the tape drive configuration file (“st.conf”) may include:

View Tape Drives in the Conf File 82: Lists all the tape drives for which active settings are maintained in the configuration file 14a . . . 14n.

Add a Tape Drive to the Conf File 84: Displays a further panel with user selectable settings for the tape device driver 10a . . . 10n to use.

Remove a Tape Drive from the Conf File 86: removes selected settings in the configuration file 14a . . . 14n for a specified tape drive by commenting out the selected settings.

Error Check the Conf File 88: Causes a routine to be performed to check the syntax of the statements in the configuration file 14a . . . 14n for any errors that could result in system failures.

Write the Conf File 90: In certain implementations, the configuration utility 20 makes a temporary copy in the computer 2 memory (not shown) of the configuration file to update. The user would harden the temporary copy and overwrite the tape configuration file 14a with the modified temporary copy by selecting the control 90. In certain implementations, the error checking routine may be automatically performed be performing the write operation to ensure that there are no syntactical errors in the update to the configure file 14a . . . 14n.

Create a Custom Entry in the Conf File 92: Allows the user to create a parameter not already predefined and selectable through the GUI 22. This allows the user to add an association of a description to a parameter code.

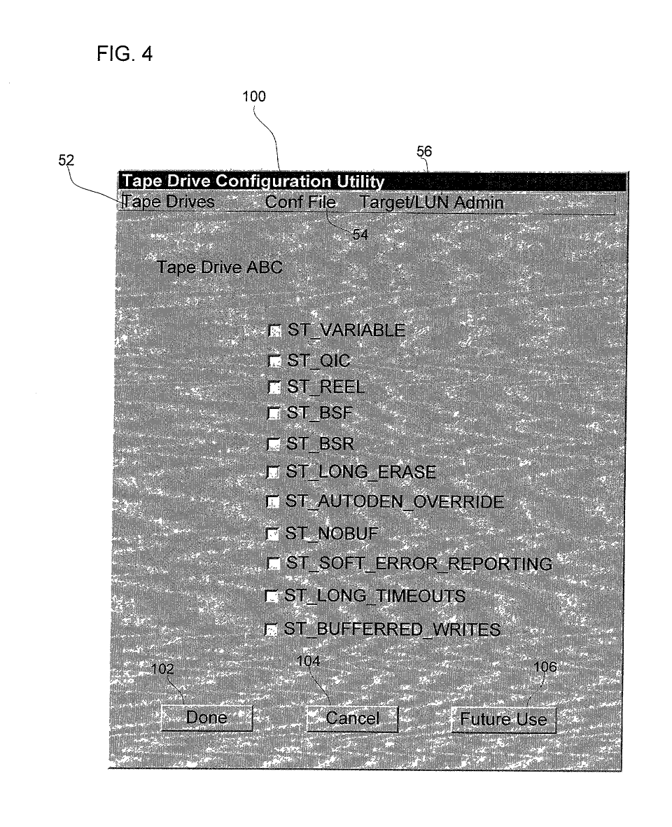

FIG. 4 illustrates an example of a GUI panel 100 that would be displayed to enable the user to enter settings for tape drive parameters in the device configuration file 4a . . . 4bn, which would hold settings for multiple devices of a specific type. The panel 100 can be displayed in response to a user selecting a displayed tape drive from a GUI panel displayed in response to selection of the “View Attached Tape Drives” control 62 in GUI panel 80 (FIG. 3). The parameters displayed in the GUI panel 100 comprise a human readable description of parameter codes that may be included in the tape drive configuration file 14a (“st.conf”). As discussed, the descriptor-code association 24 maintains the association of a human readable description and the parameter code, which may comprise a hexadecimal code or other non-descriptive string. Panel 100 displays parameters the user may select to include in the configuration file 14 for tape drive ABC. The human discernible parameters listed in GUI panel 100 that maybe selected to include as an active parameter for tape drive ABC in the configuration file 14 include, by way of example:

ST VARIABLE: indicates whether the tape device supports variable length record sizes.

ST QIC: indicates a Quarter Inch Cartridge (QIC) tape device.

ST REEL: indicates a one-half inch reel tape device.

ST BSF: indicates whether the device supports backspace over end-of-file (EOF) marks.

ST BSR: indicates whether the tape device supports the backspace record (BSR) operation If the device does not support BSR, then the tape driver 10 may emulate the action by rewinding the tape and using the forward space record operation to forward the tape to the correct file. The driver then uses forward space record to forward the tape to the correct record.

ST LONG ERASE: indicates whether the tape device needs a longer time than normal to erase.

ST AUTODEN OVERRIDE: auto-density override flag. Indicates whether the device is capable of determining the tape density automatically without issuing a “mode-select”/“mode-sense command”.

ST NOBUF: indicates the ability of the tape drive to perform buffered writes. A buffered write occurs when the device acknowledges the completion of a write request after the data has been written to the tape drive buffer, but before all of the data has been written to the tape.

ST SOFT ERROR REPORTING: indicates whether the tape device will perform a “request sense” or “log sense” command when the device is closed. Currently, only Exabyte and DAT drives support this feature.

ST LONG TIMEOUTS: indicates whether the tape device requires timeouts that are five times longer than usual for normal operation.

ST BUFFERED WRITES: indicates whether data is buffered by the tape drive device when data is written to the tape device. The application 6a, 6b . . . 6n may receive acknowledgement of completion of the write request before the data has been written to tape.

The above described tape drive parameters the user may set through the GUI panel 100 are for illustrative purpose, and additional, different or fewer parameters may be provided. The GUI panel 100 further displays a “Done” button 102 which closes the GUI panel 100 and returns the user to a previous panel. The changes made to the tape configuration file 14a would remain in the temporary file in computer 2 memory until the user selects the “Write the Conf File” control 90 (FIG. 3) to replace the tape configuration file 14a with the temporary version including the modifications. Alternatively, the user can select the “Future Use” control 106 to save the modified configuration file 14a on disk until the user selects the “Write the Conf File” control 90.

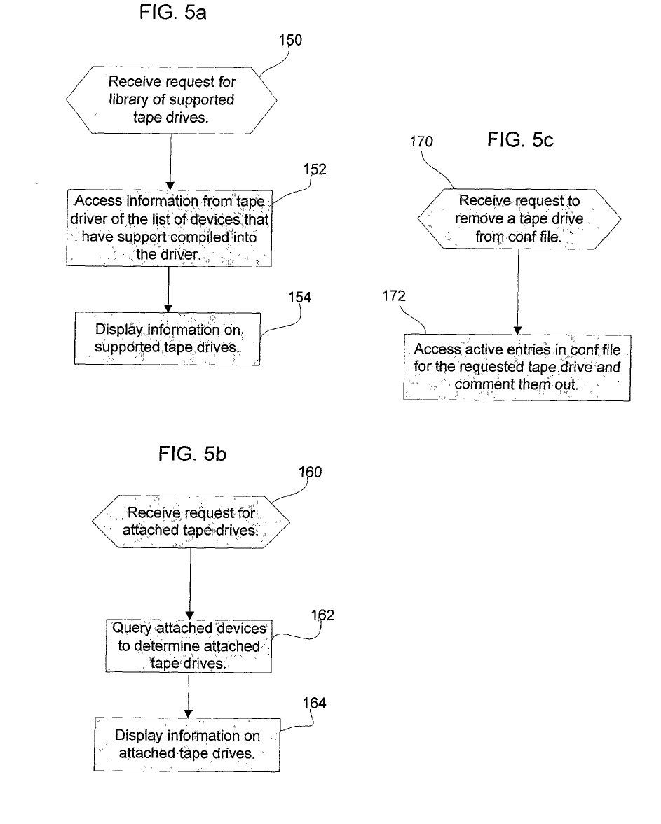

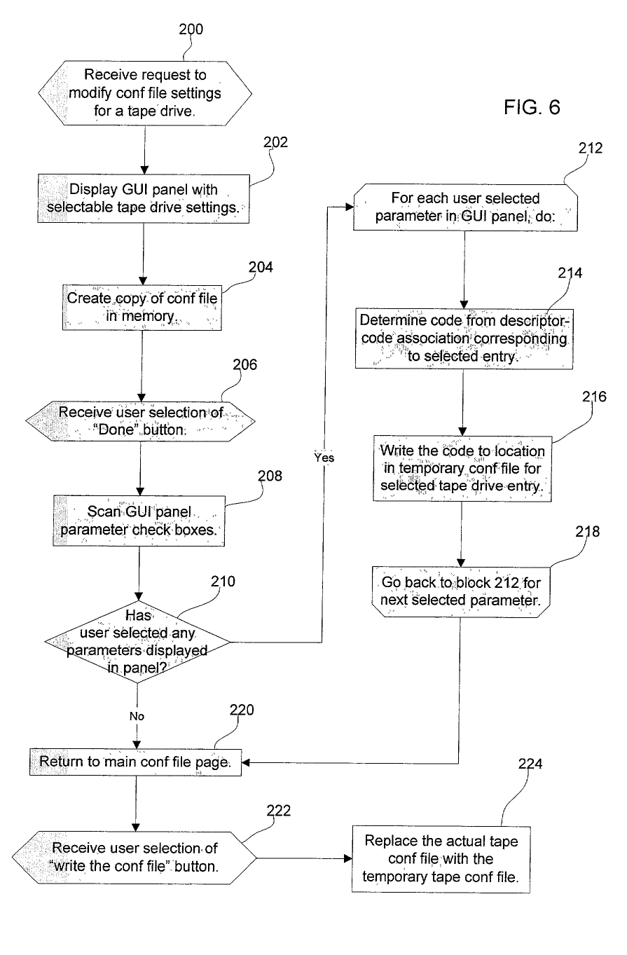

FIGS. 5a, 5b, and 5c and 6 illustrate logic implemented in the configuration utility 20 to perform operations requested by the user through the GUI 22. With respect to FIG. 5a, in response to user selection of “View Library of Supported Tape Drives” control 60 (FIG. 2) (at block 150), the configuration utility 20 accesses (at block 152) information from the tape drive on the list of devices that have their support compiled into the device driver 10a, such as through the driver parameters 12a. The information on the tape drives supported by the device driver 10a is then displayed (at block 154).

With respect to FIG. 5b, in response to user selection of the “View Attached Tape Drives” control 62 (FIG. 2) (at block 160), the configuration utility 20 queries (at block 162) attached devices using an inquiry command, such as the SCSI inquiry command, to determine the attached tape drives and then displays (at block 164) information thereon.

With respect to FIG. 5c, in response to receiving user selection of the “Remove a Tape Drive from the Conf File” control 86 (FIG. 3), the configuration utility 20 accesses the active entries in the device configuration file 14a and comments them out so they are no longer active and accessible to the tape driver 14a.

FIG. 6 illustrates logic implemented in the configuration utility 20 to enable the user to modify the parameter settings in the device configuration file 14a (“st.conf”). Control begins at block 200 upon receiving a request to modify the configuration file 14a, which may comprise selection of a tape drive displayed in the GUI 22. The GUI panel 100 (FIG. 4) including the selectable tape drive settings is displayed (at block 202). The configuration utility 20 then creates (at block 204) a temporary copy of the configuration file 14a in the computer system memory (not shown) to which changes can be made before hardening in the device configuration file 14a. This allows the user to cancel the changes or save them in a yet further file to avoid effecting the current settings.

When the user selects (at block 206) the “Done” button 102, the configuration utility 20 scans (at block 208) the GUI panel 100 to determine any parameter check boxes the user may have selected. If (at block 210) the user has selected parameters displayed in the GUI panel 100, then the configuration utility 20 performs a loop at blocks 212 through 218 for each user selected parameter. For each user selected parameter, the configuration utility 20 determines (at block 214) the code from the descriptor-code association 24 corresponding to the selected entry. The configuration utility 20 then writes the determined code, e.g., the hexadecimal code, to the temporary configuration file in memory to the section in the configuration file providing parameters for the selected tape drive. In writing the code, the configuration utility 20 would conform to the syntactical requirements of the configuration file. After updating the temporary configuration file with the codes for the user selected parameters, the configuration utility 20 returns (at block 220) to display the main tape drive GUI panel 80 (FIG. 2). Alternatively, if (at block 210) the user has not selected any parameters for the selected tape drive displayed in the main tape drive GUI panel 80, then control also proceeds to block 220 to return to the main tape drive GUI panel 80. Upon receiving (at block 222) user selection of the “Write the Conf File” control 90 (FIG. 3), the configuration utility 20 hardens the temporary configuration file in the computer 2 memory to the device configuration file 14a to apply the parameter selections the user made.

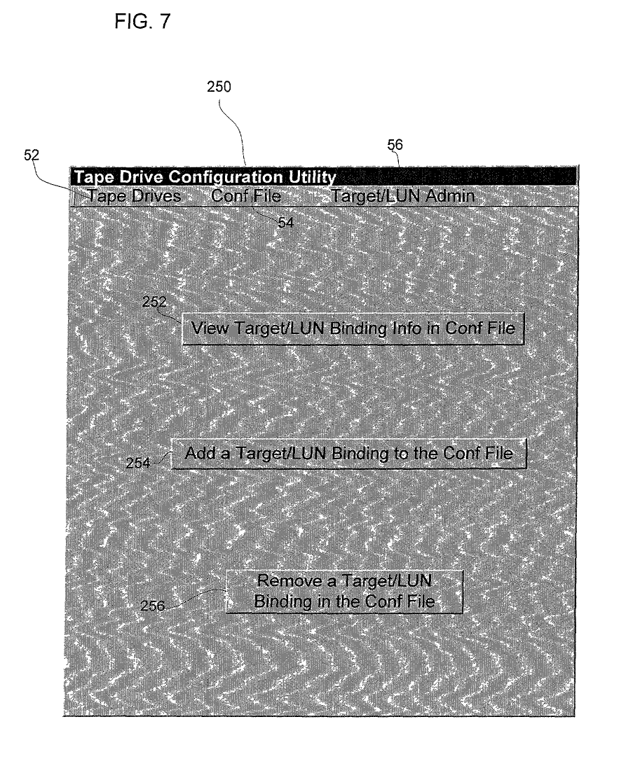

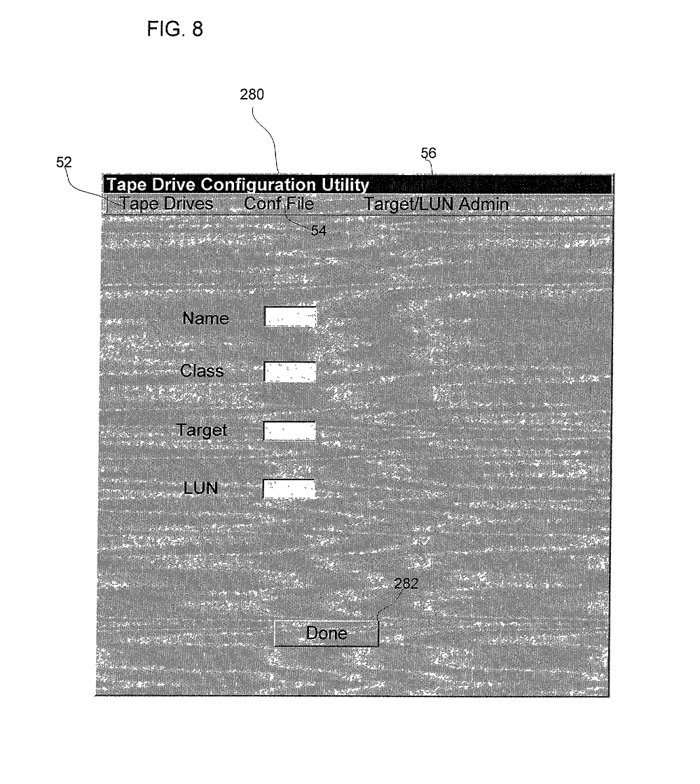

FIGS. 7 and 8 illustrate the GUI panels displayed to allow the user to specify the configuration of attached SCSI devices. FIG. 7 illustrates a Target/Logical Unit Number (LUN) admin GUI panel 250 displayed in response to selection of the Target/LUN admin 56 menu item from any of the panels 50, 80, 100. The Target/LUN admin GUI panel 250 is used to manage the assignment of a target number defining the location of a specific device, identified by LUN number and name, in a chain of devices, such as a SCSI chain. In GUI interface 250, the operations the user may invoke to manage the assignment of target numbers to devices comprises:

View Target/LUN Binding Info in Conf File 252: Accesses the assignment of target numbers to devices, identified by name and LUN, that is maintained in t5he device configuration file 14a . . . 14n. After reviewing this information, unused ports can be removed from the list in the configuration file 14a . . . 14n to improve boot time performance by eliminating the requirement that the computer scan unused ports during the boot process. The list informs the computer which ports to scan. If a device is present on a port, but the computer does not scan the device, then such bypassed device would not be listed as part of the device tree for the computer. On the other hand if all the ports are listed, but most of the ports do not have a device attached, then the computer has to wait for the inquiry to timeout for each of the ports that do not have attached devices, which significantly increases the boot time. For these reasons, providing a list of used ports in the device configuration file 14a . . . 14n to check during initialization substantially reduces the time required for initialization.

Add a Target/LUN Binding to the Conf File 254: Selection displays a further GUI panel, shown as panel 280 in FIG. 8, in which the user may enter the assignment of a target number to a device, identified by name and LUN.

Remove a Target/LUN Binding to the Conf File 256: selection comments-out the target number assignment for the selected device in the configuration file 14a.

FIG. 8 illustrates an add target/LUN binding window 280 in which the user may enter a target number for a specific device, identified by the device name LUN number, and device class, e.g., SCSI. Selecting “Done” 282 adds the target/LUN binding information entered in the window 280 into the tape configuration file 14a for use during initialization when detecting devices in a chain, such as a SCSI chain, where each device in the chain connects to another device to form a loop of devices. Additionally, the user interface may allow entry of information for attached devices in alternative formats, such as devices in a Fibre Channel Arbitrated Loop or other loop technology.

With the described implementations and user interface, the user may modify the configuration file without having to manually edit the contents of the configuration file. This will prevent the user from entering syntactical mistakes or incorrect information. Restricting users in this manner reduces those operational problems that frequently result from user entered mistakes in the configuration file 14a . . . 14n. In turn, the number of customer service calls placed to customer support to troubleshoot problems related to user editing mistakes in the configuration file would further be reduced, thereby reducing the cost of customer service.

### Additional Implementation Details

The described configuration utility may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In certain implementations, a single configuration utility program may provide a user interface to manage and modify configuration files for multiple device types and device drivers or for only a single device type.

In the described implementations, the user interface presented by the configuration utility comprised a graphical user interface (GUI) that the user manipulates using any input device known in the art, such as a keyboard, mouse pointer, pen stylus, touch screen having comprising a display device with a touch-sensitive transparent panel, microphone for receiving voice activated commands, etc. Additionally, the user interface may comprise an audio output and input device, where the audio output device generates audio output that inform the user of the configuration options and the audio input device receives audio signals from the user to select user interface options and settings for the configuration file.

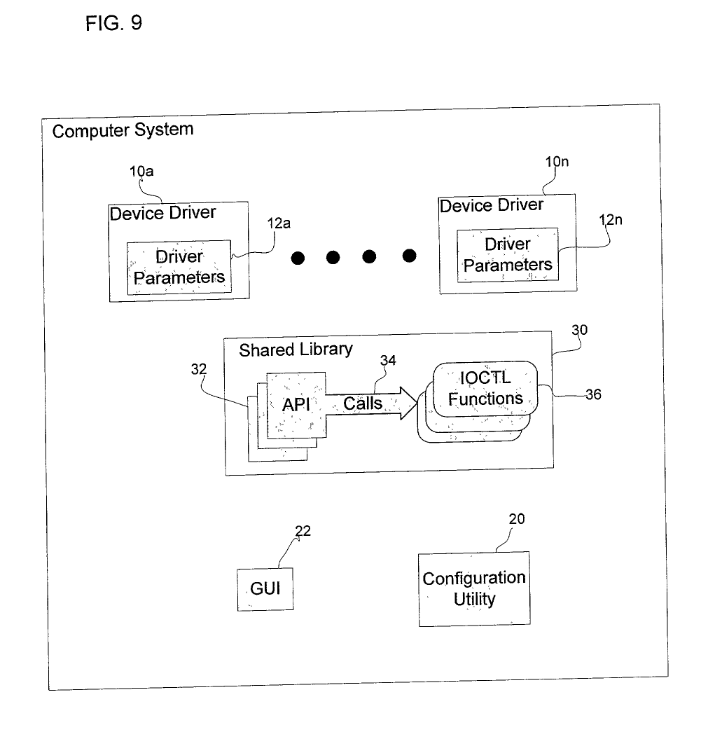

As discussed, the configuration utility 20 communicates with the device driver 10a . . . 10n when performing various configuration related operations. FIG. 9 illustrates further details of FIG. 1 including a shared library 30 of Application Programming Interfaces (API) 32 called by the configuration utility 20 and/or GUI 22 to communicate with the device drivers 10a . . . 10n in order to access information and configure the device drivers 10a . . . 10n. In certain UNIX implementations, the APIs include calls 34 to IOCTLs 36, which are device control programs used to access a device driver. The IOCTLs 36 take as parameters a file descriptor associated with a specific device that uses the device driver program and a control function. In alternative implementations, the APIs 32 may include calls 34 to other types of program interfaces to interact with the device drivers 10a . . . 10n or, alternatively, include code to communicate directly with the device drivers 14a, 14b . . . 14n. Both the GUI 22 or configuration utility 20 may call the APIs 32 in the shared library 30 to access functionality to interact with the device drivers 10a . . . 10n.

In implementations where the configuration utility 20 and GUI 22 are coded using the Java programming language, the APIs 32 may be written in the C or C++ programming language. In such implementations, the configuration utility 20 and GUI 22 would use the Java Native Interface to access the functionality of the APIs 32.

The program flow logic described in the flowcharts indicates certain events occurring in a certain order. Those skilled in the art will recognize that the ordering of certain programming steps or program flow may be modified without affecting the overall operation performed by the preferred embodiment logic, and such modifications are in accordance with the preferred embodiments.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computerized method for managing a configuration file including device parameters that define attributes of at least one device, wherein a device driver uses the device parameters to control the at least one device, comprising:
providing an association of device parameters and parameter codes for devices accessible through the device driver;
presenting information on the device parameters through a user interface;
receiving user selection of at least one of the device parameters indicated in the presented information;
determining from the association the parameter code corresponding to the user selected device parameter for each user selected device parameter; and
modifying the configuration file to include each determined parameter code.

2. The method of claim 1, further comprising:
receiving user input requesting devices supported by the device driver;
accessing information on devices that the device driver manages; and
presenting the accessed information through the user interface.

3. The method of claim 1, further comprising:
receiving user input requesting accessible devices;
querying ports to determine accessible devices; and
presenting information on the determined devices through the user interface.

4. The method of claim 3, further comprising:
receiving user input selecting one of the determined devices presented through the user interface, wherein the user interface presents the information on the selectable device parameters in response to receiving selection of one of the determined devices, and wherein the configuration file is modified to include the determined parameter code for the selected device.

5. The method of claim 1, further comprising:
receiving user input requesting information on devices for which the configuration file provides active device parameters that are used by the device driver;
scanning the configuration file to determine attached devices for which the configuration file provides active device parameters; and
presenting information on the determined attached devices through the user interface.

6. The method of claim 5, further comprising:
receiving selection of one of the determined attached devices for which the configuration file provides active device parameters; and
modifying the configuration file in a manner that prevents the device driver from using the device parameters listed in the configuration file for the selected device.

7. The method of claim 6, wherein modifying the configuration file comprises adding comment marks to statements in the configuration file including the device parameters for the selected device.

8. The method of claim 1, wherein the user interface comprises at least one Graphical User Interface (GUI) panel, wherein one panel displays information on each of the selectable device parameters and an input mechanism to enable the user to enter user input selecting at least one of the device parameters.

9. The method of claim 1, wherein the device comprises an Input/Output (I/O) device.

10. A computerized method for managing a configuration file including device parameters defining attributes of at least one device, wherein a device driver uses the device parameters to control one or more devices, comprising:
presenting a user interface through which the user enters information on a name of a device driver and an identifier of a device;
receiving user input for at least one device indicating the identifier of the device and the name of the device driver that is used to communicate with the device; and
storing the received user input for the at least one device in the configuration file, wherein the named device driver uses the stored user input information during initialization to establish communication with the devices for which user input is received.

11. The method of claim 10, wherein user input is received for a plurality of devices linked together and wherein the received identifier of each device comprises a number of the device relative to the other devices linked together.

12. The method of claim 11, wherein the devices linked together communicate using the Small Computer System Interface (SCSI) protocol and wherein the inputted number identifying the device comprises a SCSI target number assigned to the device.

13. The method of claim 11, wherein the devices comprise data storage devices, further comprising:
receiving user input for each storage device indicating a logical volume number associated the data maintained in the data storage device.

14. A system for managing a configuration file, wherein the system is in communication with at least one device, comprising:
a processor
a computer readable medium;
a configuration file in the computer readable medium including device parameters that define attributes of the device;
a device driver in the computer readable medium that uses the device parameters to control one or more of the devices;
an association in the computer readable medium of device parameters and parameter codes for devices accessible through the device driver;
program code in the computer readable medium that the processor executes to perform:
(i) presenting information on the device parameters through a user interface;
(ii) receiving user selection of at least one of the device parameters indicated in the presented information;
(iii) determining from the association the parameter code corresponding to the user selected device parameter for each user selected device parameter; and
(iv) modifying the configuration file to include each determined parameter code.

15. The system of claim 14, wherein the program code is executed by the processor to further perform:
receiving user input requesting information on devices for which the configuration file provides active device parameters that are used by the device driver;
scanning the configuration file to determine attached devices for which the configuration file provides active device parameters; and
presenting information on the determined attached devices through the user interface.

16. The system of claim 15, wherein the program code is executed by the processor to further perform:
receiving selection of one of the determined attached devices for which the configuration file provides active device parameters; and
modifying the configuration file in a manner that prevents the device driver from using the device parameters listed in the configuration file for the selected device.

17. The system of claim 1, wherein the user interface comprises at least one Graphical User Interface (GUI) panel, wherein one panel displays information on each of the selectable device parameters and an input mechanism to enable the user to enter user input selecting at least one of the device parameters.

18. A system method for managing a configuration file including device parameters that define attributes of at least one device, wherein a device driver uses the device parameters to control the at least one device, comprising:
means for providing an association of device parameters and parameter codes for devices accessible through the device driver;
means for presenting information on the device parameters through a user interface;
means for receiving user selection of at least one of the device parameters indicated in the presented information;
means for determining from the association the parameter code corresponding to the user selected device parameter for each user selected device parameter; and
means for modifying the configuration file to include each determined parameter code.

19. The system of claim 18, further comprising:
means for receiving user input requesting devices supported by the device driver;
means for accessing information on devices that the device driver manages; and
means for presenting the accessed information through the user interface.

20. The system of claim 18, further comprising:
means for receiving user input requesting accessible devices;
means for querying ports to determine accessible devices; and
means for presenting information on the determined devices through the user interface.

21. The system of claim 20, further comprising:
means for receiving user input selecting one of the determined devices presented through the user interface, wherein the user interface presents the information on the selectable device parameters in response to receiving selection of one of the determined devices, and wherein the configuration file is modified to include the determined parameter code for the selected device.

22. The system of claim 18, wherein the user interface comprises at least one Graphical User Interface (GUI) panel, wherein one panel displays information on each of the selectable device parameters and an input mechanism to enable the user to enter user input selecting at least one of the device parameters.

23. A system method for managing a configuration file including device parameters defining attributes of at least one device, wherein a device driver uses the device parameters to control one or more devices, comprising:
means for presenting a user interface through which the user enters information on a name of a device driver and an identifier of a device;
means for receiving user input for at least one device indicating the identifier of the device and the name of the device driver that is used to communicate with the device; and
means for storing the received user input for the at least one device in the configuration file, wherein the named device driver uses the stored user input information during initialization to establish communication with the devices for which user input is received.

24. The system of claim 23, wherein the devices linked together communicate using the Small Computer System Interface (SCSI) protocol and wherein the inputted number identifying the device comprises a SCSI target number assigned to the device.

25. An article of manufacture including code for managing a configuration file including device parameters that define attributes of at least one device, wherein a device driver uses the device parameters to control the at least one device, and wherein the code causes operations comprising:
providing an association of device parameters and parameter codes for devices accessible through the device driver;
presenting information on the device parameters through a user interface;
receiving user selection of at least one of the device parameters indicated in the presented information;
determining from the association the parameter code corresponding to the user selected device parameter for each user selected device parameter; and
modifying the configuration file to include each determined parameter code.

26. The article of manufacture of claim 25, further comprising:
receiving user input requesting devices supported by the device driver;
accessing information on devices that the device driver manages; and
presenting the accessed information through the user interface.

27. The article of manufacture of claim 25, further comprising:
receiving user input requesting accessible devices;
querying ports to determine accessible devices; and
presenting information on the determined devices through the user interface.

28. The article of manufacture of claim 27, further comprising:
receiving user input selecting one of the determined devices presented through the user interface, wherein the user interface presents the information on the selectable device parameters in response to receiving selection of one of the determined devices, and wherein the configuration file is modified to include the determined parameter code for the selected device.

29. The article of manufacture of claim 25, further comprising:
receiving user input requesting information on devices for which the configuration file provides active device parameters that are used by the device driver;
scanning the configuration file to determine attached devices for which the configuration file provides active device parameters; and
presenting information on the determined attached devices through the user interface.

30. The article of manufacture of claim 29, further comprising:
receiving selection of one of the determined attached devices for which the configuration file provides active device parameters; and
modifying the configuration file in a manner that prevents the device driver from using the device parameters listed in the configuration file for the selected device.

31. The article of manufacture of claim 30, wherein modifying the configuration file comprises adding comment marks to statements in the configuration file including the device parameters for the selected device.

32. The article of manufacture of claim 25, wherein the user interface comprises at least one Graphical User Interface (GUI) panel, wherein one panel displays information on each of the selectable device parameters and an input mechanism to enable the user to enter user input selecting at least one of the device parameters.

33. An article of manufacture including code for managing a configuration file including device parameters defining attributes of at least one device, wherein a device driver uses the device parameters to control one or more devices, wherein the code causes operations comprising:
presenting a user interface through which the user enters information on a name of a device driver and an identifier of a device;
receiving user input for at least one device indicating the identifier of the device and the name of the device driver that is used to communicate with the device; and
storing the received user input for the at least one device in the configuration file, wherein the named device driver uses the stored user input information during initialization to establish communication with the devices for which user input is received.

34. The article of manufacture of claim 33, wherein user input is received for a plurality of devices linked together and wherein the received identifier of each device comprises a number of the device relative to the other devices linked together.

35. The article of manufacture of claim 34, wherein the devices linked together communicate using the Small Computer System Interface (SCSI) protocol and wherein the inputted number identifying the device comprises a SCSI target number assigned to the device.

36. The article of manufacture of claim 34, wherein the devices comprise data storage devices, further comprising:
receiving user input for each storage device indicating a logical volume number associated the data maintained in the data storage device.
